(19) United States
(12) Patent Application Publication
(10) Pub. No.: US 2006/0219924 A1
(43) Pub. Date: Oct. 5, 2006

(54) Infrared imaging sensor and vacuum packaging method thereof

(76) Inventors: Tzong-Sheng Lee, Chunan Town (TW); Ping-Wei Lin, Taoyuan Hsien (TW); Hsiang-Fu Chen, Chu Tung Town (TW); Hung-Ti Li, Taichung City (TW); Jeng-Long Ou, Chutung Town (TW)

Correspondence Address: RABIN & BERDO, P.C., Suite 500, 1101 14 Street, N.W., Washington, DC, 20005, US

(21) Appl. No.: 11/137,456

(22) Filed: May 26, 2005

(30) Foreign Application Priority Data
Apr. 1, 2005 (TW) 94110631

(51) Int. Cl. G01J 5/02

(52) U.S. Cl. 250/352

(57) ABSTRACT

An infrared imaging sensor and a vacuum packaging method thereof are described. The infrared imaging sensor includes a ceramic base, a metal cap and an infrared filter. The ceramic base has an infrared imaging chip attached thereon and the metal cap includes a getter deposited on an inner surface of the metal cap. The infrared filter seals an opening of the metal cap. The ceramic base, the metal cap and the infrared filter are heated in a vacuum chamber to activate the getter, and to solder the ceramic base, the metal cap and the infrared filter together thereby vacuum packaging the infrared imaging sensor.

### RELATED APPLICATIONS

The present application is based on, and claims priority from, Taiwan Application Serial Number 94110631, filed Apr. 1, 2005, the disclosure of which is hereby incorporated by reference herein in its entirety.

### FIELD OF THE INVENTION

The present invention relates to an infrared imaging sensor and a manufacturing method thereof, and more particularly, to a vacuum-packaged infrared imaging sensor and a manufacturing method thereof.

### BACKGROUND OF THE INVENTION

With the rapid progress of semiconductor industry and electronic technology, the manufacturing technique of infrared imaging sensor is also advanced accordingly. The infrared imaging sensor not only can be applied in medical science, such as body temperature measurement, but also can be applied in scientific, commercial and military purposes, such as laser detection, missile guidance, infrared spectrometers, remote controls, security devices and thermal image detection. The infrared imaging sensor mainly can be classified into a thermal type and a photon type, wherein the thermal-typed infrared imaging senor is relatively convenient for use, so that it is more popular in common applications.

Generally, the thermal-typed infrared imaging sensor is operated at about room temperature, and due to the heat conductance of air, the heat transmitted from a target heat source to the senor is lost a lot, so that an infrared imaging chip thereof has to be tightly packaged in vacuum for increasing sensitivity, wherein a getter is frequently applied to the package for assuring a certain degree of vacuum for quite a long term. For maintaining the normal operation of the infrared imaging sensor, a thermo-electrical cooler is often used in the package as a temperature stabilizer, thereby performing temperature stability control.

The conventional packaging method for the thermal-typed infrared imaging sensor is performed generally by using a ceramic base and an infrared filter, wherein an infrared imaging chip is fixed on a thermoelectric temperature stabilizer, and the thermoelectric temperature stabilizer is fixed on the ceramic base. After the ceramic base and the infrared filter are soldered, the interior of the package is vacuumed via a vacuuming pipe connected to the ceramic base. After the vacuum state in the package is reached, the vacuuming pipe is sealed, wherein a getter is placed in advance in the vacuuming pipe for maintaining the vacuum state in the sensor.

Hence, the conventional packaging method for the thermal-typed infrared imaging sensor needs to perform a vacuuming process after the packaging process is done, and then to seal the vacuuming pipe, thus not only resulting in complicated process steps, but also causing the amount of the getter to be limited to the volume of the vacuuming pipe, since the getter is filled in the vacuuming pipe. If the amount of the getter is not sufficient, the sensitivity of the infrared imaging sensor and the degree of vacuum state in the sensor will be affected significantly.

### SUMMARY OF THE INVENTION

In view of the forgoing background of the invention, the infrared imaging sensor has to be maintained at a certain degree of vacuum so as to ensure the normal operation. The conventional packaging method of the infrared imaging sensor not only has complicated process, but also the allocation amount of its getter is restricted by the size, of the vacuuming pipe, thus resulting in a bottleneck for maintaining the degree of vacuum state in the infrared imaging sensor.

One aspect of the present invention is to provide an infrared imaging sensor and a vacuum packaging method thereof, thereby simplifying the packaging process for the infrared imaging sensor.

Another aspect of the present invention is to provide an infrared imaging sensor and a vacuum packaging method thereof for properly loading in the infrared imaging sensor, thereby increasing the allocation amount of the getter so as to meet the requirement of the degree of vacuum needed by the infrared imaging sensor.

Another aspect of the present invention is to provide an infrared imaging sensor and a vacuum packaging method thereof by using three-piece vacuum packaging components and processes, thereby not only properly loading the getter in the infrared imaging sensor, but also conveniently performing vacuum packaging for the infrared imaging sensor, so as to effectively promote the sensitivity and usage life for the infrared imaging sensor.

To achieve the aforementioned aspects, the present invention provides an infrared imaging sensor comprising a ceramic base, a metal cap and an infrared filter, wherein an infrared imaging chip is attached on the ceramic base, and the metal cap having an opening permissible to light, and a getter is deposited on an inner surface of the metal cap, and the infrared filter is used for sealing the opening of the metal cap.

The infrared imaging sensor further comprises a thermoelectric temperature stabilizer, wherein the thermoelectric temperature stabilizer is installed between the ceramic base and the infrared imaging chip, or under the ceramic base. When the thermoelectric temperature stabilizer is installed under the ceramic base, the thermoelectric temperature stabilizer is preferably attached under the ceramic base in atmosphere, after the infrared imaging sensor is vacuum packaged.

The aforementioned infrared filter further has an anti-reflection layer used for lowering the reflection ratio of infrared ray and promoting the penetration ratio of infrared ray, wherein the ceramic base, the metal cap and the infrared filter are located in a vacuum chamber, and are respectively heated so as to activate the getter and to solder the ceramic base, the metal cap and the infrared filter together.

Since the getter is filled in the inner surface of the metal cap, so that not only the reading of infrared image will not be affected, but also the area accommodating the getter can be effectively increased, thereby increasing the allocation amount of the getter.

The present invention also discloses a vacuum packaging method of an infrared imaging sensor, the method comprising the following steps. A ceramic base, a metal cap and an infrared filter are provided, wherein in infrared imaging chip is attached on the ceramic base, the metal cap having an opening permissible to light, and a getter is deposited on an inner surface of the metal cap. The infrared filter is preferably an infrared filter having an anti-reflection layer used for lowering the reflection ratio and promoting the penetration ratio for infrared ray.

The ceramic base, the metal cap and the infrared filter are placed in a vacuum chamber, and are respectively heated so as to activate the getter and to solder the ceramic base, the metal cap and the infrared filter together. The infrared imaging sensor can be further coupled with a thermoelectric temperature stabilizer, for example, the thermoelectric temperature stabilizer is installed between the ceramic base and the infrared imaging chip, or under the ceramic base.

Hence, the infrared imaging sensor and the vacuum packaging method thereof according to the present invention can effectively simplify the packaging process for the infrared imaging sensor; can properly load the getter in an inner surface of the metal cap, so that not only the reading of infrared image will not be affected, but also the allocation amount of the getter can be effectively increased, thereby enabling the infrared imaging sensor to meet the requirement of the degree of vacuum needed by the infrared imaging sensor, further promoting the sensitivity and usage life for the infrared imaging sensor.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic 3-D diagram showing the components of an infrared imaging sensor according to the present invention;

FIG. 2 is a schematic side view showing an infrared imaging sensor according to one embodiment of the present invention; and

FIG. 3 is a schematic side view showing an infrared imaging sensor according to the other embodiment of the present invention.

### DETAILED DESCRIPTION OF THE PREFERRED EMBODIMENT

The infrared imaging sensor and the vacuum packaging method thereof according to the present invention not only can effectively simplify the packaging process for the infrared imaging sensor, but also can properly load the getter in the infrared imaging sensor, thereby enabling the infrared imaging sensor to meet the requirement of the degree of vacuum needed by the infrared imaging sensor, further promoting the sensitivity and usage life for the infrared imaging sensor. Hereinafter, the features and spirit of the present invention are explained by referring to the related figures, according to preferred embodiments of the present invention.

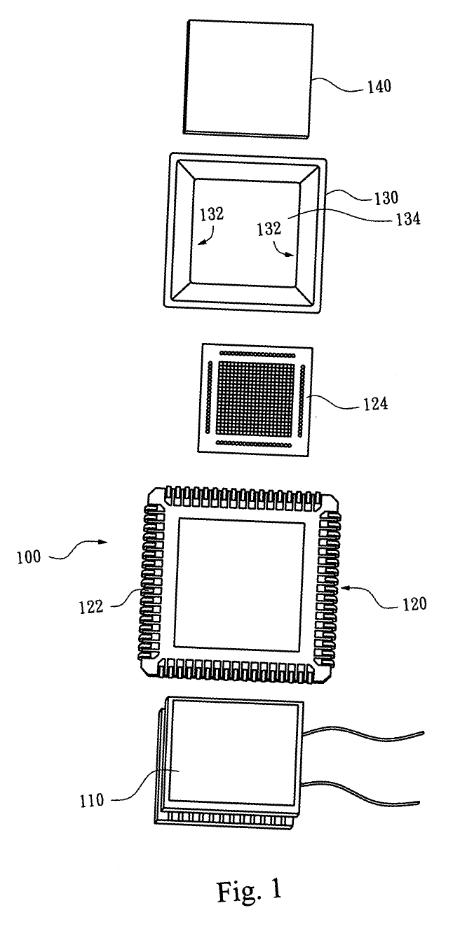

Referring to FIG. 1, FIG. 1 is a schematic 3-D diagram showing the components of an infrared imaging sensor according to the present invention. Such as shown in FIG. 1, an infrared imaging sensor 100 of the present invention comprises a filter 140, a cap 130, a base 120 and a thermoelectric temperature stabilizer 110, wherein the filter 140 located on the cap 130 is used for closing an opening 134 of the cap 130, thereby maintaining the degree of vacuum in the infrared imaging sensor 100, and meanwhile providing for infrared ray penetration, so that an infrared imaging chip 124 installed on the base 120 can perform the reading of infrared image. The infrared filter 140 is preferably an infrared filter having an anti-reflection layer used for lowering the reflection ratio and promoting the penetration ratio for infrared ray.

The thermoelectric temperature stabilizer 110 is installed under the base 120 for providing the stability of operation temperature to the infrared imaging sensor 100, wherein a pin and pad structure 122 is used for electrically connecting the infrared imaging chip 124 installed on the base 120 to external electrical circuits. The inner side of the cap 130 is deposited with a getter 132, so that after the infrared imaging sensor 100 is sealed and packaged, the degree of vacuum inside the package can be effectively maintained and promoted.

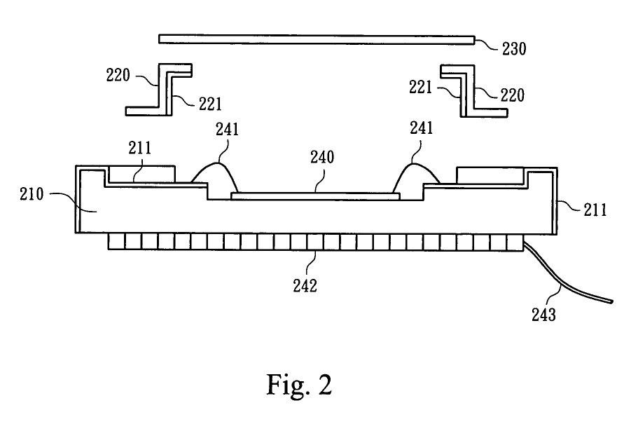

Referring to FIG. 2, FIG. 2 is a schematic side view showing an infrared imaging sensor according to one embodiment of the present invention. In order to increase the sensitivity for a thermal-typed infrared imaging senor, an infrared imaging chip has to be sealed in vacuum, and further a getter is used for assuring the requirement of the degree of vacuum for long term.

In the infrared imaging sensor of the present invention, an infrared imaging chip 240 is first fixed on a ceramic base 210, and wires 241 are used to electrically connect the infrared imaging chip 240 to a pin and pad structure 211 located on the ceramic base 210. A getter 221 is deposited in an inner surface of a metal cap 220, and preferably, the entire inner surface is filled with the getter 221 so as to increase the allocation amount of the getter 221. An infrared filter 230 is installed on the metal cap 220 for allowing infrared ray to pass through.

For effectively sealing the infrared imaging chip 240 in the infrared imaging sensor of the present invention and maintaining appropriate degree of vacuum therein, at first, the ceramic base 210 on which the infrared imaging chip 240 has been installed, the metal cap 220 and the infrared filter 230 are placed in a vacuum chamber, and then are respectively heated so as to activate the getter 221, and solder the ceramic base 210, the metal cap 220 and the infrared filter 230 together.

In the infrared imaging sensor of the present invention, the ceramic base 210, the metal cap 220 and the infrared filter 230 are heated and combined together, so that the infrared imaging sensor not only can be briefly assembled, and further, the degree of vacuum therein can be effectively maintained after the getter 221 located on the inner side of the metal cap 220 is activated. Since the getter 221 is properly loaded in the inner side of the metal cap 220, the getter 221 can be attached on the inner side of the metal cap 220 with a larger area, such as filled in the inner side of the metal cap 220, so that the getter 221 can have the biggest gas-absorbing efficacy, thereby properly maintaining the degree of vacuum in the infrared imaging sensor.

Hence, the use of the infrared imaging sensor of the present invention is advantageous in conveniently performing a packaging process; effectively increasing the degree of vacuum for the infrared imaging sensor; and further increasing the usage life and sensitivity of the infrared imaging sensor. After the infrared imaging sensor is packaged, a thermoelectric temperature stabilizer 242 is attached under the ceramic base 210 for controlling the operation temperature of the infrared imaging sensor, thereby enabling the infrared imaging sensor to stably perform detection. The power required for the thermoelectric temperature stabilizer 242 is provided via a wire 243, and the thermoelectric temperature stabilizer 242 is preferably a thermo-electrical cooler.

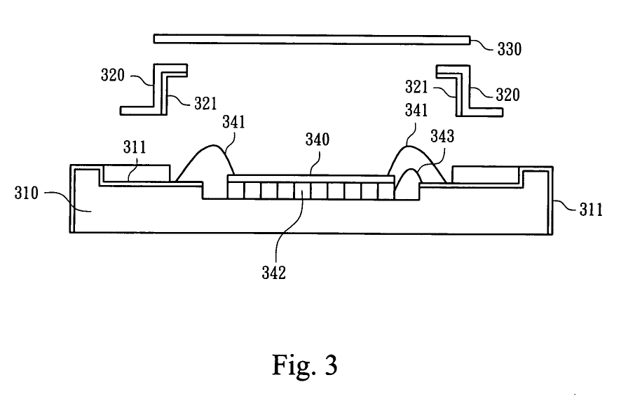

Referring to FIG. 3, FIG. 3 is a schematic side view showing an infrared imaging sensor according to the other embodiment of the present invention. Such as shown in FIG. 3, a thermoelectric temperature stabilizer 342 is fixed on a ceramic base 310, and then an infrared imaging chip 340 is attached on the thermoelectric temperature stabilizer 342. The infrared imaging chip 340 is electrically connected to a pin and pad structure 311 located on the ceramic base 310 via wires 341, and the thermoelectric temperature stabilizer 342 is electrically connected to the pin and pad structure 311 via a wire 343.

While the infrared imaging sensor is being packaged, the aforementioned ceramic base 310, the metal cap 320 and the infrared filter 330 are first placed in a vacuum chamber, and then are respectively heated so as to activate a getter 321 and to solder the ceramic base 310, the metal cap 320 and the infrared filter 330 together, wherein the getter 321 is filled in an inner surface of the metal cap 320, so as to increase the allocation amount of the getter 321; to increase the degree of vacuum in the infrared imaging sensor after packaging; and to effectively increase the usage life and sensitivity of the infrared imaging sensor.

Hence, the use of the infrared imaging sensor of the present invention is advantageous not only in conveniently performing a packaging process, but also in effectively increasing the degree of vacuum for the infrared imaging sensor, and further in effectively increasing the usage life and sensitivity of the infrared imaging sensor.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar strictures.

What is claimed is:

1. An infrared imaging sensor, comprising:
a ceramic base, wherein an infrared imaging chip is attached on the ceramic base;
a metal cap having an opening permissible to light, wherein a getter is deposited on an inner surface of the metal cap; and
an infrared filter installed on the metal cap.

2. The infrared imaging sensor of claim 1, further comprising:
a thermoelectric temperature stabilizer installed between the ceramic base and the infrared imaging chip.

3. The infrared imaging sensor of claim 1, further comprising:
a thermoelectric temperature stabilizer installed under the ceramic base.

4. The infrared imaging sensor of claim 1, wherein the thermoelectric temperature stabilizer is attached under the ceramic base in atmosphere, after the infrared imaging sensor is vacuum packaged.

5. The infrared imaging sensor of claim 1, wherein the infrared filter has an anti-reflection layer.

6. The infrared imaging sensor of claim 1, wherein the ceramic base, the metal cap and the infrared filter are packaged in a vacuum chamber.

7. The infrared imaging sensor of claim 6, wherein the ceramic base, the metal cap and the infrared filter are respectively heated in the vacuum chamber so as to activate the getter and to solder the ceramic base, the metal cap and the infrared filter together.

8. The infrared imaging sensor of claim 6, wherein the getter is filled in the inner surface of the metal cap so as to increase the getter to an allocation amount.

9. A vacuum packaging method of an infrared imaging sensor, comprising:
providing a ceramic base;
attaching an infrared imaging chip on the ceramic base;
providing a metal cap having an opening permissible to light, wherein a getter is deposited on an inner surface of the metal cap;
providing an infrared filter installed on the metal cap;
placing the ceramic base, the metal cap and the infrared filter in a vacuum chamber; and
respectively heating the ceramic base, the metal cap and the infrared filter in the vacuum chamber so as to activate the getter and to solder the ceramic base, the metal cap and the infrared filter together.

10. The vacuum packaging method of an infrared imaging sensor according to claim 9, further comprising:
installing a thermoelectric temperature stabilizer between the ceramic base and the infrared imaging chip.

11. The vacuum packaging method of an infrared imaging sensor according to claim 9, further comprising:
installing a thermoelectric temperature stabilizer under the ceramic base.

12. The vacuum packaging method of an infrared imaging sensor according to claim 11, wherein the thermoelectric temperature stabilizer is attached under the ceramic base in atmosphere.

13. The vacuum packaging method of an infrared imaging sensor according to claim 9, wherein the infrared filter has an anti-reflection layer.

14. The vacuum packaging method of an infrared imaging sensor according to claim 9, wherein the getter is filled in the inner surface of the metal cap so as to increase the getter to an allocation amount.

15. An infrared imaging sensor, comprising:
a ceramic base, wherein an infrared imaging chip is attached on the ceramic base;
a metal cap having an opening permissible to light, wherein a getter is deposited on an inner surface of the metal cap; and
an infrared filter installed on the metal cap, wherein the ceramic base, the metal cap and the infrared filter are respectively heated in a vacuum chamber so as to activate the getter and to solder the ceramic base, the metal cap and the infrared filter together.

16. The infrared imaging sensor of claim 15, further comprising:
a thermoelectric temperature stabilizer installed between the ceramic base and the infrared imaging chip.

17. The infrared imaging sensor of claim 15, further comprising:
a thermoelectric temperature stabilizer installed under the ceramic base.

18. The infrared imaging sensor of claim 15, wherein the thermoelectric temperature stabilizer is attached under the ceramic base in atmosphere.

19. The infrared imaging sensor of claim 15, wherein the infrared filter has an anti-reflection layer.

20. The infrared imaging sensor of claim 15, wherein the getter is filled in the inner surface of the metal cap so as to increase the getter to an allocation amount.
